(19) United States
(12) Patent Application Publication
(10) Pub. No.: US 2026/0015035 A1
(43) Pub. Date: Jan. 15, 2026

(54) ELECTRO-HYDRAULIC POWER ASSISTED STEERING ASSEMBLY OF A VEHICLE AND METHOD OF ASSEMBLING THE SAME

(71) Applicant: ZF CV Systems Global GmbH, Bern (CH)

(72) Inventors: Praveen VIJAYENTHRAN, Karaikudi (IN); Senthil DORAI RAJ, Chennai (IN); Sriram JAYARAMAN, Chennai (IN)

(21) Appl. No.: 19/264,877

(22) Filed: Jul. 10, 2025

(30) Foreign Application Priority Data
Jul. 12, 2024 (IN) 202441053343

(51) Int. Cl. B62D 5/09

(52) U.S. Cl. CPC B62D 5/092

(57) ABSTRACT

An electro-hydraulic power assisted steering assembly for a vehicle is disclosed. The assembly includes a steering gear unit which in turn has a valve housing. The valve housing includes a first projection defined with a first internal threaded bore. There is an electric motor housing which in turn comprises a second projection defined with a second internal threaded bore. There is a lock nut having a first external threaded section and a support nut having a second external threaded section. The second external threaded section of the support nut is configured to be engaged with the second internal threaded bore of the second projection and the first external threaded section of the lock nut is configured to be engaged with the first internal threaded bore to couple the electric motor housing with the steering gear unit.

### CROSS REFERENCE TO RELATED APPLICATIONS

This application claims benefit to Indian Patent Application No. IN 202441053343, filed on Jul. 12, 2024, which is hereby incorporated by reference herein.

### FIELD

The present disclosure generally belongs to the technical field of automobiles. Particularly to a steering assembly of a vehicle, and in particular to an electro-hydraulic power assisted steering assembly of the vehicle and method of assembling the same.

### BACKGROUND

The steering assembly serves as the crucial interface between the driver and the vehicle, requiring precision above all. The steering assembly should also be smooth, compact, and lightweight. Additionally, the steering assembly offers the driver an excellent sense of the road surface and aid in returning the wheels to the straight-ahead position. Typically, the front wheels are turned by a hand-operated steering wheel connected via the steering column. This column may incorporate several joints, enabling slight deviations from a straight line and contributing to the collapsible design that enhances driver safety in frontal crashes.

As vehicles have become heavier coupled with wider and larger tires, the effort to manually turn the steering wheel has increased. Consequently, power-assisted steering was introduced to aid the driver. A notable benefit of power-assisted steering is speed-adjustable assistance, providing substantial help at low speeds and minimal assistance at high speeds. This feature is increasingly standard in all new vehicles.

Electro-hydraulic power-assisted steering (EHPAS) is a sophisticated system designed to enhance the steering capabilities of a vehicle. This system combines elements of both hydraulic and electric power steering, aiming to improve efficiency, control, and performance. It features an electric motor that drives a worm gear arrangement to provide power assistance to the steering system. Sensors feed data on driving speed, steering torque, and steering speed to the system's control unit, which calculates the steering assistance. The hydraulic pump then generates the needed hydraulic pressure, which is directed into a steering cylinder divided into two chambers by a separator piston. Depending on the steering angle and vehicle speed, the system dynamically adjusts the pressure in each chamber to provide the driver with the appropriate level of steering support. Broadly, the EHPAS system includes a steering gear unit and an electric motor housing. The electric motor housing houses an electric motor which provides the power to assist in steering. The electric motor housing may be coupled to the steering gear unit through a valve housing.

The orientation of the electric motor housing may vary depending on packaging constraints of different vehicles. Conventionally, valve housing, referencing a particular orientation of the electric motor housing had to be created. This led to problems such as high tool developmental cost, material cost and potentially increasing the number of valve housing variants which is not desirable.

The information disclosed in this background of the disclosure section is for enhancement of understanding of the general background of the invention and should not be taken as an acknowledgement or any form of suggestion that this information forms the prior art already known to a person skilled in the art.

### SUMMARY

In an embodiment, the present disclosure provides an electro-hydraulic power assisted steering assembly of a vehicle. The assembly includes a steering gear unit having a valve housing, wherein the valve housing comprises a first projection and the first projection is defined with a first internal threaded bore. The assembly includes an electric motor housing having a second projection and the second projection is defined with a second internal threaded bore. The assembly includes a lock nut having a first external threaded section corresponding to the first internal threaded bore of the first projection of the valve housing, and a support nut having a second external threaded section corresponding to the second internal threaded bore of the second projection of the electric motor housing, where the second external threaded section of the support nut engages with the second internal threaded bore and the first external threaded section of the lock nut engages with the first internal threaded bore to couple the electric motor housing with the steering gear unit.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates an exploded view of an electro-hydraulic power assisted steering assembly of a vehicle according to an embodiment of the present disclosure;

FIG. 2 illustrates an assembled view of the electro-hydraulic power assisted steering assembly of FIG. 1, according to an embodiment of the present disclosure;

FIG. 3 illustrates an exploded view of a portion of the electro-hydraulic power assisted steering assembly of FIG. 2 including an electric motor housing, according to an embodiment of the present disclosure;

FIG. 4a illustrates a perspective view of a valve housing of a steering gear unit of the electro-hydraulic power assisted steering assembly of FIG. 2, according to an embodiment of the present disclosure;

FIG. 4b illustrates a perspective view of a portion of the electric motor housing of the electro-hydraulic power assisted steering assembly of FIG. 2, according to an embodiment of the present disclosure;

FIG. 5 illustrates a sectional view of the electro-hydraulic power assisted steering assembly of FIG. 2, according to an embodiment of the present disclosure;

FIG. 6 is a flowchart illustrating method of assembling the electro-hydraulic power assisted steering assembly, according to an embodiment of the present disclosure; and

FIG. 7 illustrates a schematic view of the vehicle comprising a steering system and electro-hydraulic power assisted steering assembly according to an embodiment of the present disclosure.

### DETAILED DESCRIPTION

The present disclosure provides an electro-hydraulic power assisted steering assembly for a vehicle and method of assembling the same. In the present disclosure, the steering assembly includes a unanimous valve housing that would accommodate any or 360° orientation of electric motor housing of the steering assembly, thus reducing tool developmental cost and material cost.

In one aspect of the present disclosure, an electro-hydraulic power assisted steering assembly for a vehicle is disclosed. The assembly comprises a steering gear unit which in turn comprises a valve housing. The valve housing includes a first projection which is defined with a first internal threaded bore. The assembly further includes an electric motor housing having a second projection. The second projection is defined with a second internal threaded bore. The assembly comprises a lock nut having a first external threaded section corresponding to the first internal threaded bore of the first projection of the valve housing. The assembly further comprises a support nut having a second external threaded section corresponding to the second internal threaded bore. The second external threaded section of the support nut is configured to be engaged with the second internal threaded bore. Further, the first external threaded section of the lock nut is configured to be engaged with the first internal threaded bore of the first projection of the steering gear unit to couple the electric motor housing with the steering gear unit.

In an embodiment of the present disclosure, the first projection and the second projection extend along a longitudinal axis of the steering gear unit and the electric motor housing respectively.

In an embodiment of the present disclosure, the support nut is configured to be torqued against the second projection of the electric motor housing to engage the second external threaded section and the second internal threaded bore.

In an embodiment of the present disclosure, the support nut is configured to support the lock nut on the second projection of the electric motor housing.

In an embodiment of the present disclosure, the lock nut is configured to be torqued against the first projection of the valve housing to engage the first external threaded section and the first internal threaded bore.

In an embodiment of the present disclosure, a circumferential surface of the lock nut is configured to abut against a first circumferential surface of the support nut and a second circumferential surface of the support nut is configured to abut against a circumferential surface of the first projection of the valve housing.

In an embodiment of the present disclosure, the electric motor housing is oriented in a range of 0° to 360° with respect to the steering gear unit.

In another aspect of the present disclosure, a steering system of a vehicle comprises an electro-hydraulic power assisted steering assembly as disclosed above.

In yet another aspect of the present disclosure, a vehicle comprises an electro-hydraulic power assisted steering assembly as disclosed above.

In still another aspect of the present disclosure, a method of assembling an electro-hydraulic power assisted steering assembly as disclosed above, is disclosed. The method comprises positioning the lock nut on the second projection of the electric motor housing, engaging the second external threaded section of the support nut with the second internal threaded bore of the second projection of the electric motor housing such that the second circumferential surface of the support nut is configured to abut against the circumferential surface of the first projection of the valve housing. The method further includes engaging the first external threaded section of the lock nut with the first internal threaded bore of the first projection of the steering gear unit and torquing the lock nut against the valve housing such that the circumferential surface of the lock nut is configured to abut against the first circumferential surface of the support nut.

The foregoing summary is illustrative only and is not intended to be in any way limiting. In addition to the illustrative aspects, embodiments, and features described above, further aspects, embodiments, and features will become apparent by reference to the drawings and the following detailed description.

The disclosure itself, however, as well as a mode of use, and advantages thereof, will best be understood by reference to the following detailed description of an embodiment when read in conjunction with the accompanying drawings. One or more embodiments are now described, by way of example only, with reference to the accompanying drawings wherein like reference numerals represent like elements.

The figures depict embodiments of the disclosure for purposes of illustration only. One skilled in art will readily recognize from the following description that alternative embodiments of the system illustrated herein may be employed without departing from the principles of the disclosure described herein.

### DETAILED DESCRIPTION OF THE EMBODIMENTS

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiments thereof have been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a system, assembly or method that comprises a list of components or steps does not include only those components or steps but may include other components or steps not expressly listed or inherent to such setup or device or method. In other words, one or more elements in a system or apparatus or method proceeded by “comprises . . . a” does not, without more constraints, preclude the existence of other elements or additional elements in the system, apparatus or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in art to practice the disclosure, and it is to be understood that other embodiments may be utilized and that changes may be made without departing from the scope of the present disclosure. The following description is, therefore, not to be taken in a limiting sense.

The following detailed description is merely exemplary in nature and is not intended to limit application and uses. Furthermore, there is no intention to be bound by any theory presented in the preceding background or summary or the following detailed description. It is to be understood that the disclosure may assume various alternative orientations and step sequences, except where expressly specified to the contrary. It is also to be understood that the specific devices or components illustrated in the attached drawings and described in the following specification are simply exemplary embodiments of the inventive concepts defined in the appended claims. Hence, specific dimensions or other physical characteristics relating to the embodiments that may be disclosed are not to be considered as limiting, unless the claims expressly state otherwise. Hereinafter, preferred embodiments of the present disclosure will be described referring to the accompanying drawings. While some specific terms directed to a specific direction will be used, the purpose of usage of these terms or words is merely to facilitate understanding of the present invention referring to the drawings. Accordingly, it should be noted that the meaning of these terms or words should not improperly limit the technical scope of the present invention.

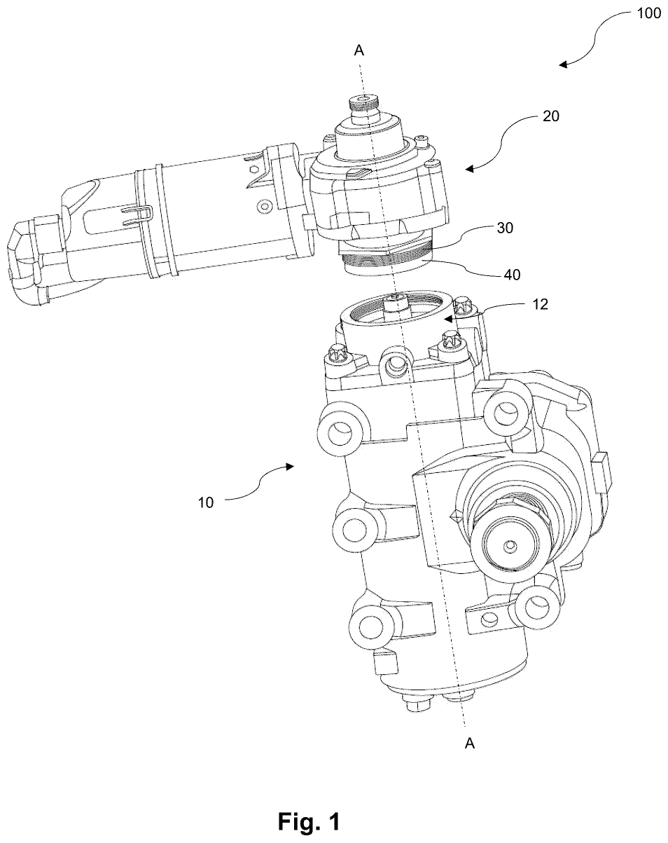

Also, it is to be understood that the phraseology and terminology used herein is for description and should not be regarded as limiting. Unless specified or limited otherwise, the terms “accommodated,” “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. It is to be understood that this disclosure is not limited to the specific devices, methods, applications, conditions, or parameters described and/or shown herein and that the terminology used herein is to describe embodiments by way of example and is not intended to be limiting of the claimed invention. Hereinafter in the following description, various embodiments will be described. For purposes of explanation, specific configurations and details are outlined to provide a thorough understanding of the embodiments. However, it will also be apparent to one skilled in the art that the embodiments may be practiced without the specific details. Furthermore, well-known features may be omitted or simplified in order not to obscure the embodiment being described. Henceforth, the steering assembly is elucidated in detail referring to FIG. 1 to FIG. 7.

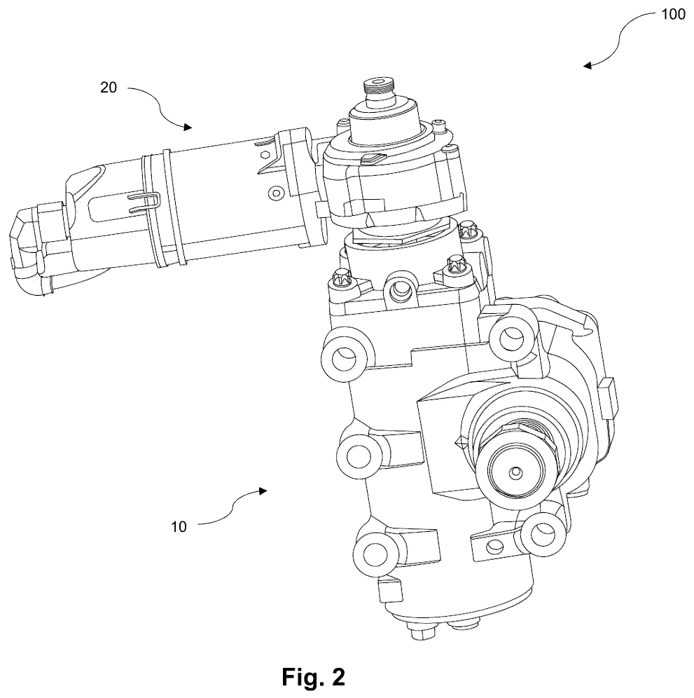

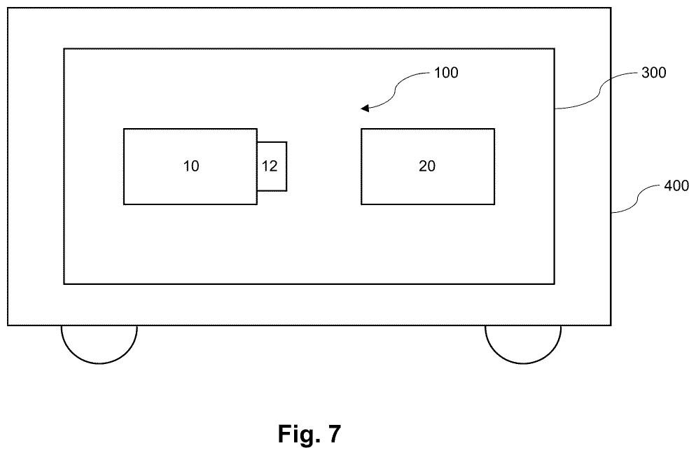

FIG. 1 and FIG. 2 illustrate exploded view and assembled view of the electro-hydraulic power assisted steering assembly 100 for a vehicle 400 (shown in FIG. 7) respectively. The electro-hydraulic power assisted steering assembly 100 may be alternatively referred herein as steering assembly 100. The vehicle 400 may typically be a commercial vehicle such as trucks, buses etc. However, type of vehicle 400 should not construed as a limitation of the present disclosure, as the present disclosure may be applicable for vehicles such as but not limited to four-wheeled vehicle including passenger cars.

The electro-hydraulic power assisted steering assembly 100 or steering assembly 100 may broadly include a steering gear unit 10 and an electric motor housing 20. The steering gear unit 10 may house a gear assembly such as but not limited to rack and pinion gear assembly to transfer motion of steering wheel to wheels of the vehicle. The steering gear unit 10 may also house components to assist and ease the motion of steering wheel [not shown]. In an embodiment, the steering gear unit 10 may house hydraulic components [not shown] to provide hydraulic assistance for steering the vehicle. The electric motor housing 20 may house an electric motor and a gear assembly to further provide assistance to the steering of the vehicle 400 by selectively drawing power from the electric motor. The electric motor provides power assistance to the steering system via hydraulic pressure. Sensors may feed data on driving speed, steering torque, steering speed and various related parameters to the steering assembly control unit, which calculates the steering assistance. The pump may then generate the needed hydraulic pressure, which is directed into a steering cylinder divided into two chambers by a separator piston. Depending on the steering angle and vehicle speed, the steering assembly 100 dynamically adjusts the pressure in each chamber to provide the driver with the appropriate level of steering support. In an embodiment, the electric motor of the electro-hydraulic power assisted steering assembly 100 may be configured to provide more power during maneuvering or low speed of the vehicle 400, so that steering wheel is flexible enough for maneuvering the vehicle 400. On the other hand, when the vehicle 400 is moving at a high speed, the electric motor may be configured to transmit less power so that the steering wheel is sturdy. Accordingly, the electric motor housing 20 provides assistance for steering of vehicle 400.

As shown in FIG. 1, the steering gear unit 10 includes a valve housing 12. Valve housing 12 is bolted on to the steering gear unit 10 and it has a valve arrangement to increase or decrease the oil pressure from the hydraulic pump based on the driver input on the steering wheel. In an embodiment, the electric motor housing 20 may be coupled to the steering gear unit 10 through the valve housing 12. As opposed to conventional design, where a separate valve housing 12 design was required depending on the orientation of the electric motor housing 20, in the present disclosure, a single valve housing 12 design may be used for all the different possible orientations of the electric motor housing 20. Additionally, in the present disclosure, the electric motor housing 20 need not be rotated for assembling with the steering gear unit 10, making the assembly process simpler.

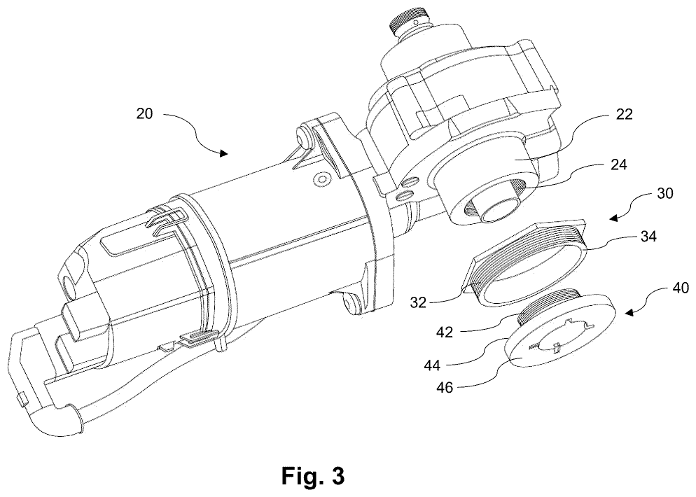

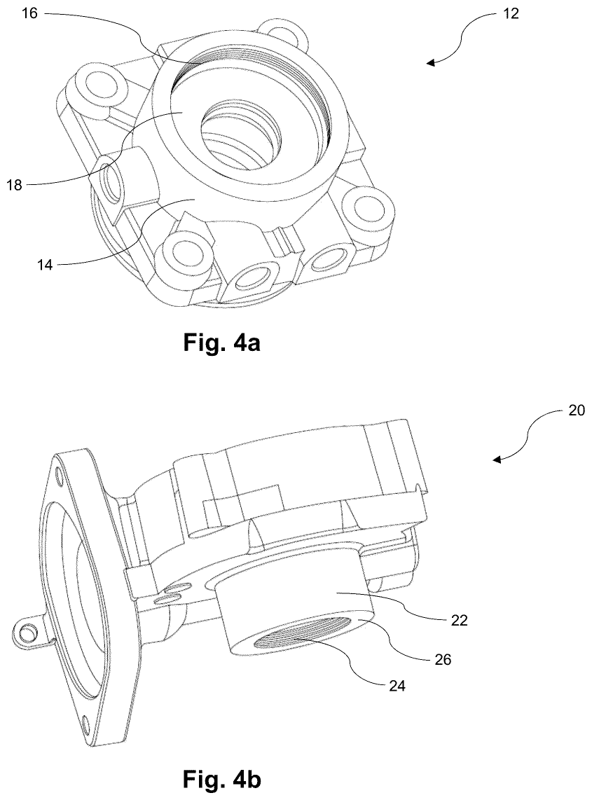

Now referring to FIG. 3 and FIG. 4b in conjunction. FIG. 3 illustrates an exploded view of electric motor housing 20, and FIG. 4b shows a perspective view of a portion of the electric motor housing 20. The electric motor housing 20 comprises a second projection 22 extending outwardly from a body of the electric motor housing 20 in a longitudinal direction along the longitudinal axis A-A (shown in FIG. 1). The second projection 22 may be defined with a second internal threaded bore 24. In an embodiment, the second internal threaded bore 24 may a bore defined in the second projection 22, the bore in turn defined with internal threads. In an embodiment, the second projection 22 may act like a female part during the assembly. In an embodiment, the second projection 22 may be of a cylindrical shape. In an embodiment, the entire bore length of the second projection 22 may be defined with the internal thread 24 and in another embodiment, a portion of the bore length of the second projection 22 may be defined with the internal threads 24.

As shown in FIG. 3, the steering assembly 100 includes a support nut 40 and a lock nut 30. The support nut 40 is configured to support the lock nut 30 upon positioning the lock nut 30 on the second projection 22 of the electric motor housing 20. In an embodiment, the lock nut 30 may be positioned with clearance to frictionally lock with the second projection 22. As shown in FIG. 3, the support nut 40 may comprise a second external threaded section 42. The second external threaded section 42 may be an extended part from a body of the support nut 40 and being defined with an external thread 42. In an embodiment, the second external threaded section 42 of the support nut 40 may correspond to or complement the second projection 22 defined with an internal threaded bore 24. Here, the second external threaded section 42 may act as a male part during the assembly. In an embodiment, the support nut 40 may be configured to be engaged with the second projection 22 of the electric motor housing 20. The second external threaded section 42 of the support nut 40 may be torqued against the second internal threaded bore 24 of the second projection 22 in order to engage the support nut 40 with the electric motor housing 20.

As also shown in FIG. 3, the lock nut 30 may include a first external threaded section 32. The first external threaded section 32 may be an extended part from a body of the lock nut 30 and being defined with an external thread 32. The diameter of the lock nut 30 may be greater than the diameter of the second projection 22. In an embodiment, the diameter of the lock nut 30 may be slightly greater than the second projection 22 such that the lock nut 30 may slide over the second projection 22 and be positioned circumferentially around the second projection 22. Therefore, the lock nut 30 may be circumferentially positioned around the second projection 22. Further, the support nut 40 which may be configured to support the lock nut 30 on the second projection 22 may do by abutting the first circumferential surface 44 of the support nut 40 with the circumferential surface 34 of the lock nut 30 when the first external threaded section 32 is tightened against the first internal thread bore 16 of the valve housing 12.

Now referring to FIG. 4a, it illustrates a perspective view of the valve housing 12. The valve housing 12 comprises a first projection 14 extending outwardly from the steering gear unit 10 in a longitudinal direction along a longitudinal axis A-A (indicated in FIG. 1). The first projection 14 may be defined with a first internal threaded bore 16. In an embodiment, the first internal threaded bore 16 may a bore defined in the first projection 14, the bore in turn defined with internal threads 16. In an embodiment, the first projection 14 may act like a female part during the assembly. In an embodiment, the first projection 14 may be of a cylindrical shape. In an embodiment, the entire bore length of the first projection 14 may be defined with the internal thread 16 and in another embodiment, a portion of the bore length of the first projection 14 may be defined with the internal threads 16. As shown in FIG. 4a, the first projection 14 may be at a substantially central portion of the valve housing 12. Further, at peripheral portion of the valve housing 12, there may be a plurality of ports for passage of hydraulic fluid which in turn has a valve arrangement to increase or decrease the oil pressure from hydraulic pump based on the driver input on the steering wheel.

Referring to FIG. 4a and FIG. 1 in conjunction. In an embodiment, the lock nut 30 may be configured to be engaged with the first projection 14 of the valve housing 12 of the steering gear unit 10. The first external threaded section 32 of the lock nut 30 may be torqued against the first internal threaded bore 16 of the first projection 14 in order to engage the lock nut 30 with the valve housing 12 of the steering gear unit 10.

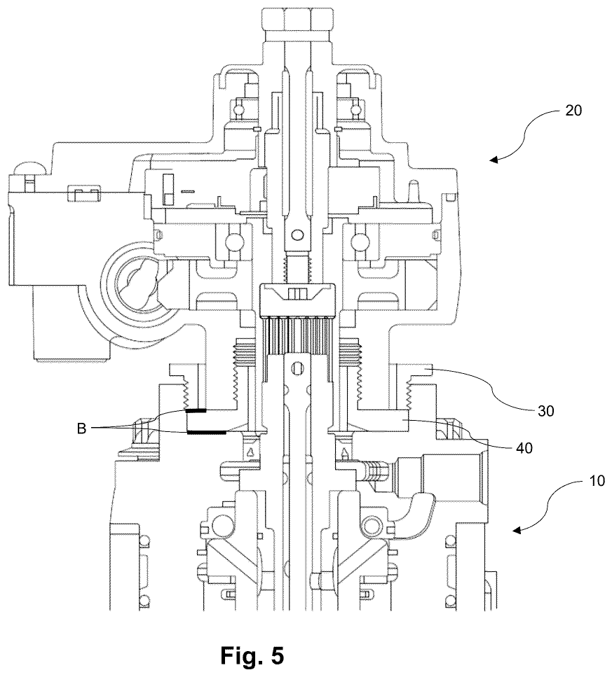

Referring to FIG. 5, it illustrates a sectional view of the steering assembly 100. During assembly, as shown in FIG. 5, to couple the electric motor housing 20 with the steering gear unit 10, firstly the electric motor housing 20 may be inserted into the valve housing 12 of the steering gear unit 10. In an embodiment, there may be a spline connection between input shaft of the electric motor housing 20 and input shaft of the steering gear unit 10 so as to transfer rotary motion from one part to the other. In an embodiment, the valve housing 12 of the steering gear unit 10 may be configured such that it can accommodate any orientation of the electric motor housing 20. The orientation of the electric motor housing 20 may range anywhere between 0° to 360°. Further, the support nut 40 may be torqued against the electric motor housing 20 such that the second external threaded section 42 of the support nut 40 engages with the second internal threaded bore 24 of the second projection 22 of the electric motor housing 20. Further, the first circumferential surface 44 of the support nut 40 abuts against the circumferential surface 34 of the lock nut 30 for the support nut 40 to support the lock nut 30. In an embodiment, the first lock nut 30 may be torqued against the valve housing 12 of the steering gear unit 10 such that the first external threaded section 32 of the lock nut 40 engages with the first internal threaded bore 16 of the first projection 14 of the valve housing 12 of the steering gear unit 10. Further, the second circumferential surface 46 (shown in FIG. 3) of the support nut 40 may abut against a circumferential surface 16 of the valve housing 12. The lock nut 30 may further be torqued against the support nut 40. Therefore, at portions marked as ‘B’, the forces may be applied by the lock nut 30 and the support nut 40 respectively. Additionally, the force may be applied by the support nut 40 and valve housing 12 as well. The forces so applied may ensure both the clamping load and fixation of orientation of the electric motor housing 20 with respect to the steering gear unit 10. Here, the electric motor housing 20 need not be rotated in order to fix the orientation of the electric motor housing, instead it may be sufficient to torque the lock nut 30 against the support nut. Thus, the assembly process becomes simple and easy to handle by avoiding rotation of heavy components such as the electric motor housing 20.

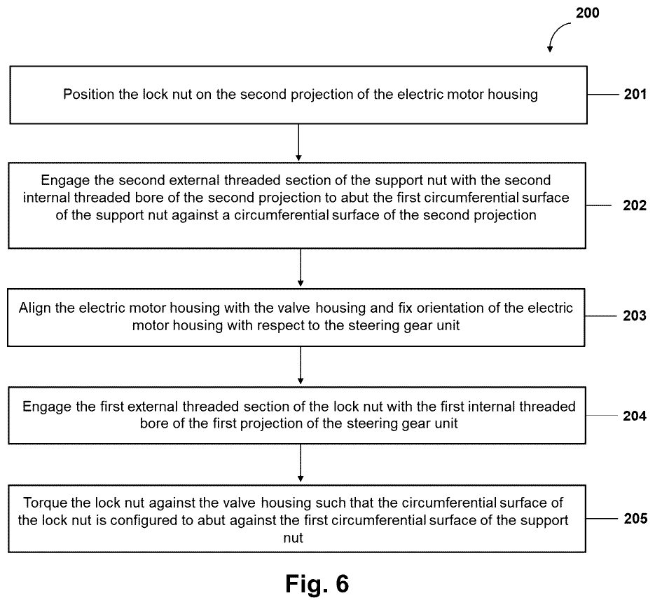

FIG. 6 illustrates a flowchart showing a method 200 for assembling the steering assembly 100, in accordance with some embodiments of the present disclosure.

The order in which the method 200 is described is not intended to be construed as a limitation, and any number of the described method blocks can be combined in any order to implement the method. Additionally, individual blocks may be deleted from the methods without departing from the scope of the subject matter described herein.

At step 201, firstly the lock nut 30 may be positioned on the second projection 22 of the electric motor housing 20. In an embodiment, the lock nut 30 may be positioned around the second projection 22 of the electric motor housing 20 and therefore, the lock nut 30 may have a diameter greater than that of the second projection 22 of the electric motor housing 20.

At step 202, the second external threaded section 42 of the support nut 40 may be engaged with the second internal threaded bore 24 of the second projection 22 of the electric motor housing 20. The engaging may happen such that the first circumferential surface 44 of the support nut 40 is configured to abut against a circumferential surface 26 of the second projection 22 of the electric motor housing 20. Further, for engagement of the second external threaded section 42 and the second internal threaded bore 24, the support nut 40 may be torqued against the second projection 22 of the electric motor housing 20.

At step 203, the electric motor housing 20 may be aligned with the valve housing 12 such that longitudinal axis A-A of both the electric motor housing 20 and the valve housing 12 are in-line. Further the electric motor housing 20 may be positioned such that it's orientation with resect to the steering gear unit 10 is fixed.

At step 204, the first external threaded section 32 of the lock nut 30 may be engaged with the first internal threaded bore 16 of the first projection 14 of the steering gear unit 10. Further, for engagement of the first external threaded section 32 and the first internal threaded bore 16, the lock nut 30 may be torqued against the first projection 14 of the valve housing 12.

At step 205, the lock nut 30 may be further torqued against the valve housing 12 such that the circumferential surface 34 of the lock nut 30 is configured to abut against the first circumferential surface 44 of the support nut 40 in order to couple the electric motor housing 20 with the steering gear unit 10.

Referring now to FIG. 7. It illustrates a schematic view of the vehicle 400. The vehicle 400 as shown in FIG. 7 includes a steering system 300 and the electro-hydraulic power assist steering assembly 100. The steering assembly 100 comprises the valve housing 12 of the steering gear unit 10 to accommodate different possible orientations of the electric motor housing 20 as per the present disclosure may be used in the steering system 300 of the vehicle 400. The steering system 300 may include linkage assembly and steering wheel among other components. In an embodiment, input shaft of the electric motor housing 20 may be coupled to the linkage assembly which may be in turn connected to the steering wheel. In an embodiment, the steering wheel may be used to transmit the driver's input torque to the input shaft of the electric motor housing 20 which may in turn be coupled to the steering gear unit 10. Thereby, as per vehicle requirements, torque generated may actually be a combined effect of the steering gear unit 10 using hydraulic power and electric motor housing 20 using electric power.

Some of the technical advantages of the present disclosure are indicated herein below.

The valve housing 12 of the present disclosure is configured such that it may accommodate the electric motor housing 20 in any orientation ranging from 0° to 360° orientation. Thus, a single unanimous valve housing 12 design may be suitable for all the types of the electric motor housing 20. With this, the tool development cost, material cost may be saved. The present disclosure also avoids the necessity of having different variants of the valve housing 12. Additionally, the electric motor housing 20 need not be rotated in order to fix the orientation of the electric motor housing, instead it may be sufficient to torque the lock nut 30 against the support nut. Thus, the assembly process becomes simple and easy to handle by avoiding rotation of heavy component such as the electric motor housing 20.

Parts unmentioned in the present disclosure may be realized by adopting or referring to the prior art.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” While various aspects and embodiments have been disclosed herein, other aspects and embodiments will be apparent to those skilled in the art. The various aspects and embodiments disclosed herein are for purposes of illustration and are not intended to be limiting, with the true scope being indicated by the claims.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGNS

### Reference Number Description

100 Electro-hydraulic power assisted steering assembly of a vehicle/Steering assembly
10 Steering gear unit
12 Valve housing
14 First projection
16 First internal threaded bore
18 Circumferential surface of the first projection
20 Electric motor housing
22 Second projection
24 Second internal threaded bore
26 Circumferential surface of the second projection
30 Lock nut
32 First external threaded section
34 Circumferential surface of the lock nut
40 Support nut
42 Second external threaded section
44 First circumferential surface of the support nut
46 Second circumferential surface of the support nut
A-A Longitudinal axis
200 Method of assembling of the electro-hydraulic power assisted steering assembly
201-204 Steps in flowchart
300 Steering system
400 Vehicle
B Portions where the forces are applied by the lock nut and the support nut

1. An electro-hydraulic power assisted steering assembly of a vehicle, the assembly comprising:
a steering gear unit comprising a valve housing, wherein the valve housing comprises a first projection and the first projection is defined with a first internal threaded bore;
an electric motor housing comprising a second projection and the second projection is defined with a second internal threaded bore;
a lock nut comprising a first external threaded section corresponding to the first internal threaded bore of the first projection of the valve housing; and
a support nut comprising a second external threaded section corresponding to the second internal threaded bore of the second projection of the electric motor housing,
wherein, the second external threaded section of the support nut is configured to be engaged with the second internal threaded bore and the first external threaded section of the lock nut is configured to be engaged with the first internal threaded bore to couple the electric motor housing with the steering gear unit.

2. The assembly according to claim 1, wherein the first projection and the second projection extend along a longitudinal axis of the steering gear unit and the electric motor housing respectively.

3. The assembly according to claim 1, wherein the support nut is configured to be torqued against the second projection of the electric motor housing to engage the second external threaded section and the second internal threaded bore.

4. The assembly according to claim 1, wherein the support nut is configured to support the lock nut on the second projection of the electric motor housing.

5. The assembly according to claim 1, wherein the lock nut is configured to be torqued against the first projection of the valve housing to engage the first external threaded section and the first internal threaded bore.

6. The assembly according to claim 1, wherein a circumferential surface of the lock nut is configured to abut against a first circumferential surface of the support nut and a second circumferential surface of the support nut is configured to abut against a circumferential surface of the first projection of the valve housing.

7. The assembly according to claim 1, wherein the electric motor housing is oriented in a range of 0° to 360° with respect to the steering gear unit.

8. A steering system of the vehicle comprising the electro-hydraulic power assisted steering assembly as claimed in claim 1.

9. A vehicle comprising the steering system as claimed in claim 8.

10. A method of assembling the electro-hydraulic power assisted steering assembly according to claim 1, the method comprising:
positioning the lock nut on the second projection of the electric motor housing;
engaging the second external threaded section of the support nut with the second internal threaded bore of the second projection of the electric motor housing to abut a first circumferential surface of the support nut against a circumferential surface of the second projection of the electric motor housing;
aligning the electric motor housing with the valve housing and fixing orientation of the electric motor housing with respect to the steering gear unit;
engaging the first external threaded section of the lock nut with the first internal threaded bore of the first projection of the steering gear unit; and
torquing the lock nut against the valve housing such that the circumferential surface of the lock nut is configured to abut against the first circumferential surface of the support nut.
